(19) United States
(12) Patent Application Publication
(10) Pub. No.: US 2025/0084192 A1
(43) Pub. Date: Mar. 13, 2025

(54) REPROCESSABLE ADDITION-TYPE POLYMER NETWORKS BASED ON DYNAMIC HINDERED UREA BONDS

(71) Applicant: Northwestern University, Evanston, IL (US)

(72) Inventors: John Mark Torkelson, Skokie, IL (US); Mohammed Abdulaziz Bin Rusayyis, Evanston, IL (US)

(21) Appl. No.: 18/725,970

(22) PCT Filed: Jan. 31, 2023
(86) PCT No.: PCT/US23/61632

§ 371 Date: Jul. 1, 2024

Related U.S. Application Data
(60) Provisional application No. 63/310,678, filed on Feb. 16, 2022.

(51) Int. Cl. C08F 8/12

(52) U.S. Cl. CPC C08F 8/12; C08F 2810/20; C08F 2810/50

(57) ABSTRACT

Methods and compositions for making organic crosslinkers having hindered urea bonds and methods and compositions for making dynamic crosslinked polymer networks using the organic crosslinkers via addition chemistry are provided. Also provided are methods for processing and reprocessing the dynamic crosslinked polymer networks in which the crosslinkers dissociate at elevated temperatures and recombine upon cooling. Polymer networks formed using the dynamic crosslinkers can be reprocessed multiple times at modest temperatures with full recovery of crosslink density.

### CROSS-REFERENCE TO RELATED APPLICATIONS

The present application claims priority to U.S. provisional patent application No. 63/310,678 that was filed Feb. 16, 2022, the entire contents of which are incorporated herein by reference.

### BACKGROUND

Thermosets are covalently cross-linked polymers having a network structure with strong, fixed covalent bonds between chains. Conventionally cross-linked polymers, which comprise the vast majority of commercial thermosets, cannot be decross-linked after curing or flow upon heating and thus cannot be effectively recycled into high-value products at end-of-life. Their lack of recyclability is due to the presence of permanent cross-links, which restrict the flow of the chains in the network even at elevated temperature. To overcome this challenge, the concept of reprocessable polymer networks emerged. Reprocessable polymer networks, also known as covalent adaptable networks (CANs) or dynamic covalent polymer networks (DCPNs), are networks that contain sufficient levels of dynamic covalent bonds which are capable of dissociating or exchanging in response to external stimuli, such as heat or light, rendering them malleable. Examples of dynamic chemistries employed in CANs include transesterification, alkoxyamine, disulfide, urethane, hydroxyurethane, and thiourethane dynamic chemistries. Because CANs are capable of retaining the excellent properties of thermosets at service conditions but become flowable at sufficiently high temperature, they offer a potential sustainable solution to the economic and environmental issues associated with waste polymer networks.

Polyureas, formed by the reaction of isocyanates with amines, are robust, low-cost materials that are used in a wide range of applications such as coatings, elastomers, and foams. They exhibit high flexibility, durability, and superior chemical resistance. Unfortunately, polyureas cannot be recycled because of the high stability of the amide bonds in ureas as a result of conjugation effects between the lone electron pair on the nitrogen atom and the x-electrons on the carbonyl p-orbital. However, incorporating bulky substituents on the amide nitrogen-atom can weaken the amide bond by disturbing its orbital co-planarity, which reduces the conjugation effect and weakens the carbonyl-amine interaction, enabling the reversible amidolysis of amide bonds under mild conditions. (Hutchby, M. et al., Angew. Chem., Int. Ed. 2009, 48, 8721-8724; Hutchby, M. et al., Angew. Chem., Int. Ed. 2012, 51, 548-551.) Cheng and coworkers studied the effect of steric hindrance on the reaction dynamics of urea bonds and noted that urea bonds with bulky side groups on the nitrogen atom can reversibly dissociate into isocyanates and amines at mild temperature (T). (Ying, H. et al., Nat. Commun. 2014, 5, 3218-3227.) They synthesized hindered urea bond (HUB)-containing polyureas and poly(urethane-urea) materials and demonstrated their self-healing and bulk reprocessability at 37° C. and 100° C., respectively. (Ying, H. et al., 2014; Zhang, Y. et al., Adv. Mater. 2016, 28, 7646-7651.) Others have reported on HUB-based polyureas and poly(urea-urethane) networks. (Chen, M. et al., Molecules 2019, 24, 1538; Zhang, L. et al., Macromolecules 2017, 50, 5051-5060; Chen, L. et al., Macromol. Chem. Phys. 2020, 221, 1900440.)

HUBs have also been employed in the synthesis of addition-type polymer networks. In 2017, Hager et al. reported the synthesis of poly(butyl methacrylate) networks containing dynamic hindered urea bonds. (Zechel, S. et al., NPG Asia Mater. 2017, 9, e420.) The self-healing behavior of these networks was investigated by scratch-healing and bulk-healing tests. In a follow-up study, they investigated the effect of healing conditions on healing efficiency. (Abend, M. et al., Molecules 2019, 24, 3597.)

### SUMMARY

Methods of forming dynamic crosslinked polymer networks, methods of processing the dynamic crosslinked polymer networks, and method of making organic crosslinker having hindered urea bonds are provided.

One example of a method of forming a dynamic crosslinked polymer network, includes the steps of: (a) forming a mixture of: (i) a pre-formed organic crosslinker having hindered urea bonds and terminal vinyl groups; or a vinyl monomer comprising a reactive isocyanate group and a monomer comprising a hindered amine group; (ii) a monomer comprising a C—C double bond capable of undergoing addition polymerization; a polymer selected from the group consisting of polymers having a C—C double bond capable of undergoing addition polymerization; or combinations thereof; and (iii) a thermally activated free radical initiator; and (b) generating free radicals from the thermally activated free radical initiator to induce addition reactions of the organic crosslinker with the monomer, the polymer, or both, to form a dynamic crosslinked polymer network comprising hindered urea bonds.

One example of a method of processing a dynamic crosslinked polymer network of a type described herein includes the steps of: pressing the dynamic crosslinked polymer network in a mold at a temperature that induces reversible urea bond cleavage; and cooling the dynamic crosslinked polymer network to a temperature at which the reversible urea bond cleavage is arrested to form a processed dynamic crosslinked polymer network.

One example of a method of making an organic crosslinker having a hindered urea bond includes the steps of: (a) reacting a first monomer comprising an isocyanate group and at least one additional group having a C—C double bond capable of undergoing addition polymerization with a second monomer comprising a hindered amine group, in the absence of a catalyst, to form an organic crosslinker, the organic crosslinker comprising at least two groups comprising a C—C double bond capable of undergoing addition polymerization and a hindered urea bond, wherein one or both of the at least two groups comprising a C—C double bond capable of undergoing addition polymerization is a methacrylate group, an acrylamide group, an isophenyl group, a vinyl ether group, an allyl group, or an allyl ether group; and (b) removing the organic crosslinker comprising from the organic solvent.

### BRIEF DESCRIPTION OF THE DRAWINGS

Illustrative embodiments of the invention will hereafter be described with reference to the accompanying drawings.

FIG. 1A shows synthesis of HUB Cross-linker. FIG. 1B shows synthesis and (re)processing of a dynamic HUB-based polymethacrylate network.

FIG. 2 shows E′ response of a 1^{st} mold HUB-based polymethacrylate network sample.

FIG. 3 shows dynamic mechanical responses of a HUB-based polymethacrylate network as a function of processing steps.

FIGS. 4A-4B show stress relaxation curves of a HUB-based polymethacrylate network at (FIG. 4A) 80° C. (processing T) and 100° C. and (FIG. 4B) T=130-160° C. under a strain of 5%. FIG. 4C shows Arrhenius apparent activation energy of stress relaxation associated with average relaxation time for the network.

FIG. 5 shows heat flow curves of as-synthesized and molded network samples.

FIG. 6 shows stacked FTIR spectra of as-synthesized (original), 1^{st} mold, 2^{nd} mold, and 3^{rd} mold HUB-based polymethacrylate network samples.

FIG. 7 shows DMA curves of 1^{st} mold HUB-based polymethacrylate network samples synthesized at 70° C. using azobisisobutyronitrile (AIBN) as a thermally activated initiator and molded at 80° C. for 30 min or 1 h.

### DETAILED DESCRIPTION

Methods and compositions for making organic crosslinkers having hindered urea bonds and methods and compositions for making dynamic crosslinked polymer networks using the organic crosslinkers via addition chemistry are provided. Also provided are methods for processing and reprocessing (“(re)processing”) the dynamic crosslinked polymer networks in which polymer chains of the networks are covalently linked via dynamic crosslinks comprising a hindered urea linkage which dissociates upon heating and recombines upon cooling. Polymer networks formed using the disclosed dynamic crosslinkers can be reprocessed multiple times at modest temperatures with full recovery of crosslink density.

The organic crosslinkers can be synthesized by reacting an isocyanate group-containing monomer with a hindered amine group-containing monomer, wherein one or both of the isocyanate monomer and the hindered amine monomer comprises at least one group having a carbon-carbon (C—C) double bond capable of undergoing addition polymerization. Groups having a C—C double bond capable of undergoing addition polymerization include vinyl groups (i.e., two carbon atoms double bonded to each other, directly attached to a carbonyl carbon). By way of illustration, some examples of the organic crosslinkers are formed by reacting vinyl isocyanate monomers with hindered diamines, while other examples of the organic crosslinkers are formed by reacting diisocyanate monomers with vinyl hindered amine monomers.

In some embodiments, the monomers that include at least one vinyl group (e.g., a vinyl isocyanate monomer and/or a vinyl amine monomer) are methacrylate monomers and/or acrylate monomers (collectively referred to herein as (meth)acrylate monomers). Non-limiting examples of (meth)acrylate monomers that can be used include 2-isocyanatoethyl methacrylate. Examples of hindered diamines that can be used include N,N′-di-tert-butylethylenediamine. However, other types of vinyl groups can be used. For example, other groups having C—C double bonds capable of undergoing addition polymerization that may be present on the isocyanate group-containing monomer and/or the hindered amine group-containing monomer, and the organic crosslinkers made therefrom include acrylamide groups, isophenyl groups, vinyl ether groups, allyl groups, and allyl ether groups. Thus, the organic crosslinkers may be dimethacrylates, diacrylamides, diisopenyls, divinyl ethers, diallyls, or diallyl ethers.

Notably, the groups having C—C double bonds on the organic crosslinkers do not need to be the same. Thus, the C—C containing groups on the organic crosslinkers can be independently selected from acrylate groups, methacrylate groups, acrylamide groups, isophenyl groups, vinyl ether groups, allyl groups, and allyl ether groups. For example, one of the groups of a crosslinker could be a methacrylate and the other group could be an acrylate or acrylamide, or any other functional group containing a C—C double bond. Crosslinkers having different C—C double bond-containing groups can be synthesized from isocyanate group-containing monomers and the hindered amine group-containing monomers that contain different vinyl groups.

The organic crosslinkers are formed by reacting the isocyanate groups with the hindered amine groups to form hindered urea bonds. The reactions are very fast, can be performed under ambient conditions, do not require catalysis, and do not produce any byproducts. The organic crosslinkers may be synthesized in a reaction solution formed by dissolving the monomers having the isocyanate groups and the monomers having the hindered amine groups in an organic solvent or, if the monomers are soluble in one another, in a reaction solution that is free of organic solvent.

At least one of the monomers includes at least one hindered amine group. Hindered amine groups have a bulky organic substituent on the nitrogen of the amine. Bulky organic substituents include primary, secondary, and tertiary carbon groups. The substituents on the primary, secondary, or tertiary carbon include alkyl groups, such as C₁-C₁₀ alkyl groups. Generally, the organic substituent(s) on the amine in a hindered amine may be any substituent that weakens the planarity of the amide bond and, as a result, weakens the stability of the urea bond within the crosslinks, enabling the urea bonds to dissociate into an isocyanate and a hindered diamine under relatively mild conditions.

In embodiments of the crosslinkers that are formed from vinyl (meth)acrylate monomers, the dynamic crosslinkers can be represented by Formula 1: R—NH—C(O)—(R′R″R′″C)N—CH₂—CH₂—N(CR′R″R′″)—C(O)—NH—R. In this formula, each R represents an acrylate (OC(O)CHCH₂) group or a methacrylate group (OC(O)CCH₃CH₂). The (meth)acrylate groups may include an alkyl chain, such as a C₁ to C₁₀ alkyl chain, connecting the (meth)acrylate group to the NH—C(O)— group in Formula 1. For hindered amine groups in which the nitrogen atom is attached to a tertiary carbon, each R′, each R″, and each R′″ on the tertiary carbon atoms represents an alkyl group. If the carbon atom is a secondary or primary carbon, one or more of the R′, R″, and R′″ groups may be an H atom. The R′, R″, and R′″ groups may be the same or different and may be unsubstituted or substituted. In some embodiments, the R′, R″, and R′″ groups are methyl groups and the CR′R″R′″ groups are tert-butyl groups. At least in some embodiments, the crosslinker does not comprise a urethane group.

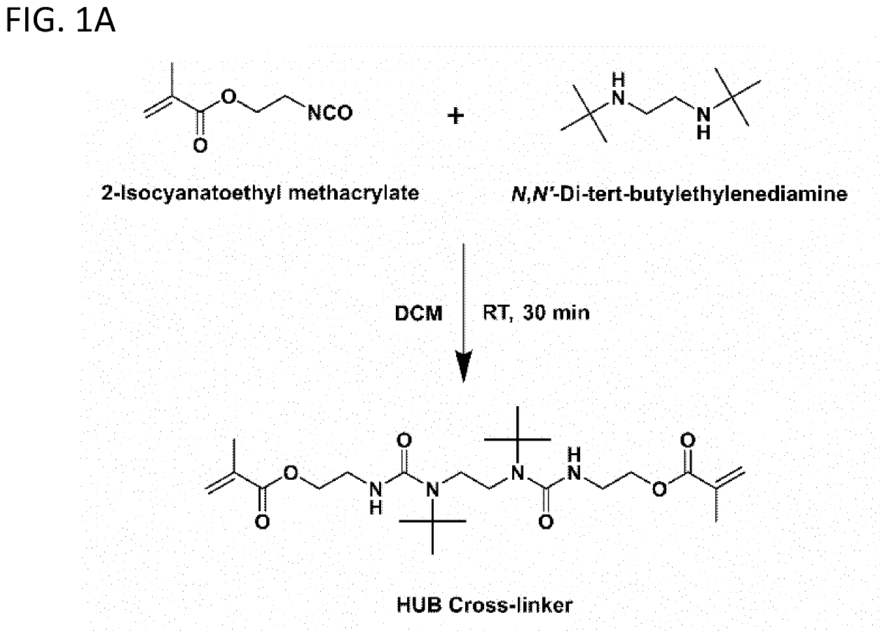

The organic crosslinkers may be dimethacrylates. One illustrative example of a dimethacrylate organic crosslinker having hindered urea bonds and terminal vinyl groups is 5,8-di-tert-butyl-4,9-dioxo-3,5,8,10-tetraazadodecane-1,12-diyl bis(2-methylacrylate), the structure of which is shown in FIG. 1A.

The reaction solutions in which the organic cross linkers are synthesized may include one or more organic solvents in which the isocyanate group-containing monomer and the hindered amine group-containing monomer are soluble. However, the reaction solution may exclude organic solvents if the isocyanate group-containing monomer and the hindered amine group-containing monomer are soluble in each other. No catalyst is required for the reaction between the isocyanate groups and amine groups, and the reaction need not be carried out under an inert (e.g., N2) atmosphere; it can be carried out under ambient conditions. Polar or non-polar organic solvents can be used to form the reaction solutions. Toluene is another example of a suitable solvent. For example, aprotic, dipolar solvents, such as dichloromethane (DCM), can be used. Notably, the synthesis of the organic crosslinkers can be completed quickly at mild temperatures. For example, it is possible to complete the synthesis in less than 2 hours (e.g., from 15 min. to 1 hour) at temperatures in the range of 20° C. to 30° C., and further including room temperature (23° C.). However, reaction times and temperatures outside of these ranges can be used.

Once formed, the organic crosslinkers having hindered urea bonds may be separated from the reaction solution and dried. The resulting organic crosslinkers having the hindered urea bonds can be used to form a dynamic crosslinked polymer network by dissolving the pre-formed organic crosslinker in an organic solvent, along with a monomer comprising a C—C double bond capable of undergoing addition polymerization, a polymer comprising a C—C double bond capable of undergoing addition polymerization, or combinations thereof, and a free radical initiator.

Alternatively, the organic crosslinkers may be formed in situ during polymer network synthesis by reacting the isocyanate group-containing monomers, the hindered amine group-containing monomers, and the monomer and/or polymers comprising a C—C double bond. If the organic crosslinker is formed in situ, the solvent is optional, as the initiator can be dissolved in the monomers and/or polymers.

In some embodiments of the methods, the monomers, polymers, and crosslinkers used to form the dynamic crosslinked polymer network are all vinyl monomers, such as methacrylates and/or acrylates. Thus, monomers and/or polymers having a polymerizable carboxylic acid end group may be excluded from the reaction mixture.

The dynamic crosslinked polymer networks are a type of covalent adaptable network (CAN) and, as such, they employ dynamic covalent bonds that undergo dynamic reactions under external stimulus, allowing recyclability of the polymer network material. The hindered urea chemistry used in the dynamic crosslinked polymers described herein is based on addition-type polymerization in which the hindered-urea-based dynamic organic crosslinkers undergo free radical polymerization with monomers having carbon-carbon double bonds, such as vinyl monomers. Using the hindered-urea-based dynamic organic crosslinkers, dynamic polymer networks can be synthesized without the need for a catalyst and can be (re)processed and exhibit full recovery of cross-link density after multiple (e.g., two, three, or more) recycling steps.

Some embodiments of the reaction solutions in which crosslinked dynamic polymer networks are synthesized from pre-formed organic crosslinkers include one or more organic solvents in which the pre-formed organic crosslinker and the monomers or polymers comprising the C—C double bonds are soluble. No catalyst is required for the reaction. Aprotic dipolar solvents, such as N,N-dimethylacrylamide (DMAc) may be used. However, other solvents capable of dissolving the reactions may also be used. Moreover, if the monomer and hindered diamine are soluble in each other, solvents can be excluded from the compositions.

The synthesis of the dynamic polymer networks can be completed quickly at mild temperatures. For example, it is possible to complete the network synthesis in less than 24 hours at temperatures in the range of 23° C. to 50° C. However, reaction times and temperatures outside of these ranges can be used.

Various monomers and polymers may be used in forming the dynamic crosslinked polymer networks, provided they each comprise at least one C—C double bond capable of undergoing addition polymerization. Illustrative monomers include vinyl monomers, including methacrylate monomers having the formula R₁—OC(O)CCH₃CH₂ and/or acrylate monomers having the formula R₁—OC(O)CHCH₂, where R₁ may be a hydrogen, alkyl (for example, a C₁ to C₆ alkyl), aryl, arylalkyl, alkenyl, or arylalkenyl. Substituted or unsubstituted versions of such vinyl monomers may be used. Combinations of different monomers may be used.

In some examples of the methods for making a dynamic crosslinked polymer network, both the reactive monomers and/or polymers and the organic crosslinker are vinyl monomers and, therefore, the dynamic polymer network is made exclusively from vinyl monomers.

Polymers which may be crosslinked using the crosslinkers include, for example, polyacrylates or polymethacrylates (collectively referred to as poly(meth)acrylates). The polymers may be homopolymers or co-polymers, including random copolymers.

In order to initiate the addition polymerization, free radicals are generated in the reaction solution. This can be accomplished using a free radical initiator present in the solution. The free radicals attack any of the C—C double bonds described above, e.g., those present in the monomers, polymers, and the dynamic crosslinker. In the case of monomers, this results in chain propagation to form polymer chains. During this process, the dynamic crosslinker becomes incorporated into polymer chains via the reaction of its vinyl groups with the polymerizable groups on the monomers or polymers. Since the dynamic crosslinker is at least bifunctional, polymer chains (or different portions of an individual polymer chain) become covalently linked together via hindered urea crosslinkages, thereby forming the polymer network. In the case of polymers, similar incorporation and crosslinking occur to form the network without the need for chain propagation.

A variety of free radical initiators may be used. The free radical initiator may be a thermally activated free radical initiator capable of generating free radicals at relatively low temperatures to prevent dissociation of the hindered urea linkages. Suitable such initiators include azo initiators such as, but not limited to, azo nitriles. Thermally activated azo initiators are polymerization initiators that include an azo group that decomposes upon exposure to heat and forms carbon radicals. Some thermally initiated free radical initiators dissociate at or near room temperature. Photoinitiation is not needed and, in fact, photoinitiators and/or photoinitiation are desirably excluded from the reaction mixture and/or the polymer network synthesis process.

An illustrative azo nitrile initiator is 2,2′-azobis(4-methoxy-2,4-dimethylvaleronitrile) (V-70), which thermally decomposes to free radicals at room temperature (20° C. to 25° C.). However, other free radical initiators which require higher temperatures to generate free radicals may be used. For example, azobisisobutyronitrile, commonly known as AIBN, can be used as an initiator. Additionally, the non-azo initiator benzoyl peroxide could also be used as a thermally activated initiator. The free radical initiator may be present in the composition at various amounts, e.g., an amount in a range of from 0.001 mol % to 10 mol % (mol % refers to the (moles of initiator)/(total moles of monomer units and dynamic crosslinker)*100).

Similarly, the dynamic crosslinker may be present in the composition at various amounts. Illustrative amounts include up to 3 mol %, up to 4 mol %, up to 5 mol %, or more. By way of illustration a dynamic crosslinker concentration in a range of from 1 mol % to 10 mol % may be used (mol % refers to the (moles of dynamic crosslinker)/(total moles of monomer units and dynamic crosslinker)*100).

The dynamic crosslinked polymer networks may be reprocessed by heating them from a temperature at which dissociation of the hindered urea bonds into isocyanates and hindered amines is inactive or substantially inactive, such as room temperature, to an elevated temperature at which the dissociation is activated or significantly enhanced. The heating may be conducted under an applied pressure and/or in a mold. Illustrative elevated temperatures include those of at least 23° C., at least 30° C., at least 60° C., and at least 90° C. By way of illustration only, temperatures in a range from 23° C. to 200° C., including from 60° C. to 150° C. can be used. The network may be reshaped (e.g., remolded) and cooled, e.g., to room temperature. During cooling, the isocyanate groups and hindered amine groups recombine, thereby reforming the polymer network. A single reprocessing cycle refers to a single round of heating, reshaping, and cooling. Notably, the heating used to reprocess the polymer networks can be quite short (e.g., 5 hours, 2 hours, 1 hour, or less) and still provide the reprocessed crosslinked polymer network with full recovery of crosslink density (as compared to the initial crosslinked polymer network prior to any reprocessing).

The dynamic crosslinked polymer networks may be characterized by properties including crosslink density after reprocessing. As noted above, the network may be characterized by full recovery of crosslink density after being subject to a reprocessing cycle. Recovery of crosslink density may be measured by measuring tensile storage modulus E′ values and glass transition temperature T_{g} values using DMA as described in the Example below. Full recovery means that the E′ and/or T_{g} values for the reprocessed network are the same (within error) as those of the initial network prior to any reprocessing. The reprocessing cycle may be that used in the Example below, e.g., 80° C. for 1 hour and compression into sheets at 16 MPa. Full recovery of crosslinking density may be obtained after one, two, or more cycles of reprocessing.

The following definitions may be used herein:

Alkyl group refers to a linear, branched or cyclic alkyl group in which the number of carbons may range from, e.g., 1 to 24, 1 to 12, 1 to 6, or 1 to 4. The alkyl group may be unsubstituted, by which it is meant the alkyl group contains no heteroatoms. The alkyl group may be substituted, by which it is meant an unsubstituted alkyl group in which one or more bonds to a carbon(s) or hydrogen(s) are replaced by a bond to non-hydrogen and non-carbon atoms.

Alkenyl group refers to a mono- or polyunsaturated, linear, branched or cyclic alkenyl group in which the number of carbons may range from, e.g., 2 to 24, 2 to 12, 2 to 6, etc. The alkenyl group may be unsubstituted or substituted as described above with respect to alkyl groups.

Aryl group refers to a monocyclic aryl group having one aromatic ring or a polycyclic group having fused aromatic rings (e.g., two, three, etc. rings). Monocyclic aryl groups may be unsubstituted or substituted as described above with respect to alkyl groups. However, substituted monocyclic aryl groups also refer to an unsubstituted monocyclic aryl group in which one or more carbon atoms are bonded to an unsubstituted or substituted alkane (i.e., arylalkyl), an unsubstituted or substituted alkene (i.e., arylalkenyl), or an unsubstituted or substituted monocyclic aryl group or a polycyclic aryl group. The meaning of unsubstituted and substituted alkanes and unsubstituted and substituted alkenes follows the meaning described above for unsubstituted and substituted alkyl and alkenyl groups, respectively. Polycyclic aryl groups are unsubstituted.

### Example

This Example presents the synthesis of a catalyst-free polymethacrylate network cross-linked with a HUB-based cross-linker and demonstrates its bulk reprocessability with full recovery of cross-link density after recycling. This Example further studies the network rheology, including stress relaxation behavior, at elevated T.

The HUB-based cross-linker, 5,8-di-tert-butyl-4,9-dioxo-3,5,8,10-tetraazadodecane-1,12-diyl bis(2-methylacrylate), was synthesized by reacting 2-isocyanatoethyl methacrylate with N,N′-di-tert-butylethylenediamine. The cross-linker synthesis was performed under ambient conditions and in the presence of dichloromethane (DCM) as solvent without any catalyst (FIG. 1A). The exothermic reaction was completed within 30 min with a 98% yield. The identity of the obtained white solid product was confirmed by ¹H NMR, ¹³C NMR, and FTIR spectroscopies. The synthesized cross-linker was also characterized by differential scanning calorimetry (DSC). The DSC thermogram of the product showed a melting peak at 93° C., which is in agreement with the literature value, further supporting the identity of the obtained product. (Zechel, S. et al., 2017.)

To examine the utility of the cross-linker in the synthesis of addition-type CANs, the cross-linker was reacted with a vinyl monomer by free radical polymerization. Because HUBs undergo slow dissociative reactions at moderate T (37° C.), for initial studies the network was polymerized at room temperature (RT) to prevent any issues associated with HUB dissociation during network synthesis. To achieve full cross-linking of the network at low polymerization T, the use of a monomer leading to a polymer with a relatively low glass transition temperature (T_{g}) is required. Thus, n-hexyl methacrylate (HMA) was selected to serve as the main building block of the network. It was found that HUB Cross-linker (see FIGS. 1A-B) did not dissolve in hexyl methacrylate. However, it was observed that adding N,N-dimethylacetoamide (DMAc) dissolved HUB Cross-linker in HMA. Thus, to synthesize the network, a solution of HUB Cross-linker and 19 equiv HMA was mixed in DMAc.

Free radical polymerization was performed at room temperature (RT; 23° C.) using the azo-based low-T thermal initiator V-70. The polymerization mixture gelled within 5 h, but the reaction was allowed to proceed overnight to achieve full conversion. The obtained gel was washed with DCM/methanol mixtures and dried in a vacuum oven to remove any solvent residuals and/or unreacted materials. The dried gel was insoluble in toluene, indicating that a network was obtained. The DSC-measured T_{g} of the network was 16° C., substantially higher than the T_{g} of linear poly(hexyl methacrylate) of −6° C. (Bin Rusayyis, M. et al., Macromolecules 2020, 53, 8367-8373.) It is well known that cross-linked polymers exhibit slightly higher T_{g}s compared to their linear counterparts. However, the 20° C. increase in T_{g} may be attributed to the bulky substituents on the HUB cross-linker. Given the high cost of V-70 initiator, the use of a more conventional and cost-effective initiator is desired for large-scale applications. Thus, the synthesis of HUB-cross-linked poly(hexyl methacrylate) networks was carried out using AIBN as initiator at 70° C. After 24 h, the obtained gel was washed and dried using similar conditions applied to the networks synthesized at RT with V-70 initiator. No significant difference was observed between the networks synthesized using V-70 and AIBN initiators regarding visual appearance, swelling, and T_{g}. The observations indicate that dissociation of HUBs during the network synthesis does not lead to undesired side reactions that would result in deleterious effects on network properties.

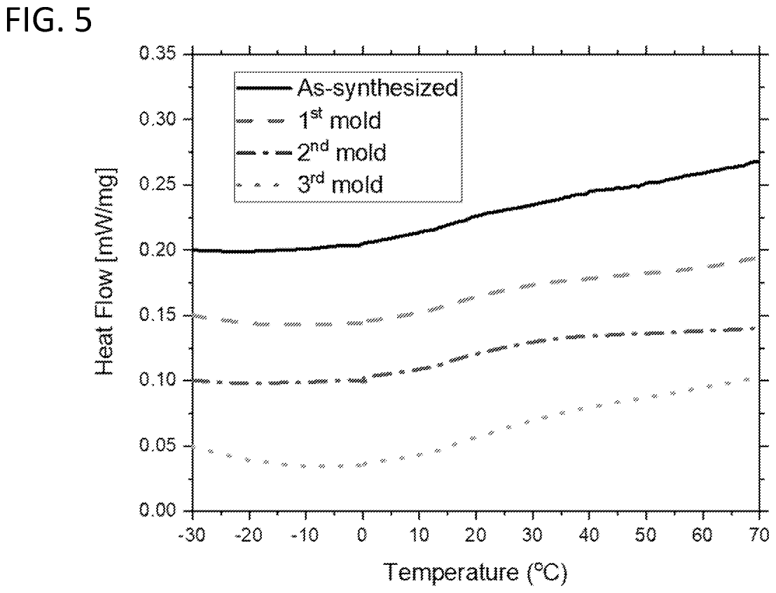

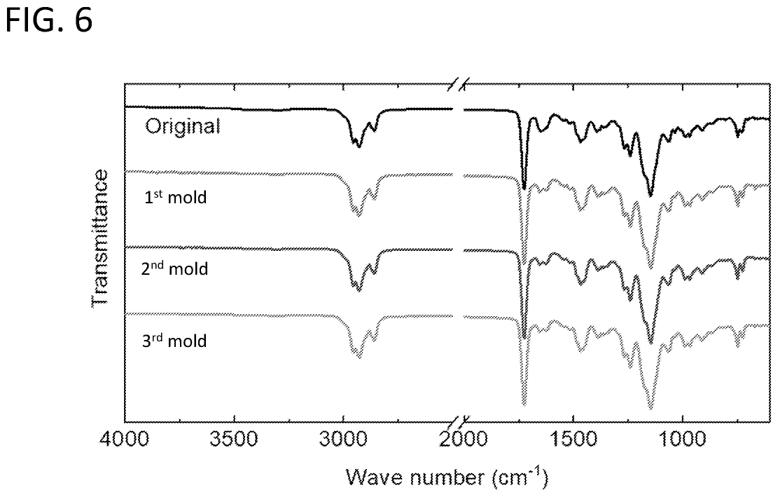

To investigate processability, small pieces of the synthesized network were compression molded under a pressure of 16 MPa at 80° C. for 1 h using a PHI hot press. As shown in FIG. 1B, an intact, transparent ˜1 mm sheet was formed after processing. Like the as-synthesized network, the processed network swelled in toluene with high gel content (>99%) and exhibited a similar T_{g} (15° C.). For the polymethacrylate network with only 5 mol % HUB content, excellent processability was achieved. Recyclability was also validated by twice reprocessing the 1^{st} mold sample to yield homogenous, transparent sheets that also exhibited T_{g}s (FIG. 5) like the as-synthesized sample. In addition, FTIR spectra of the as-synthesized and (re)processed networks were indistinguishable (FIG. 6), which demonstrates that the molding process had no significant effect on network chemical composition. The possibility of applying lower T for the processing of HUB-based poly(hexyl methacrylate) networks was further investigated. It was observed that the network was processable into good quality sheets at 60° C. for 1 h. With a 40° C. processing T, intact sheets were obtained but were of lower visual quality than sheets processed at 80° C. and 60° C. for the same processing time of 1 h. However, when processing time was increased to 24 h, the sheet quality improved significantly. Small pieces of synthesized network were also molded at RT for 24 h. The pieces self-healed to form intact sheets, but the sheets were inhomogeneous and had poor optical properties.

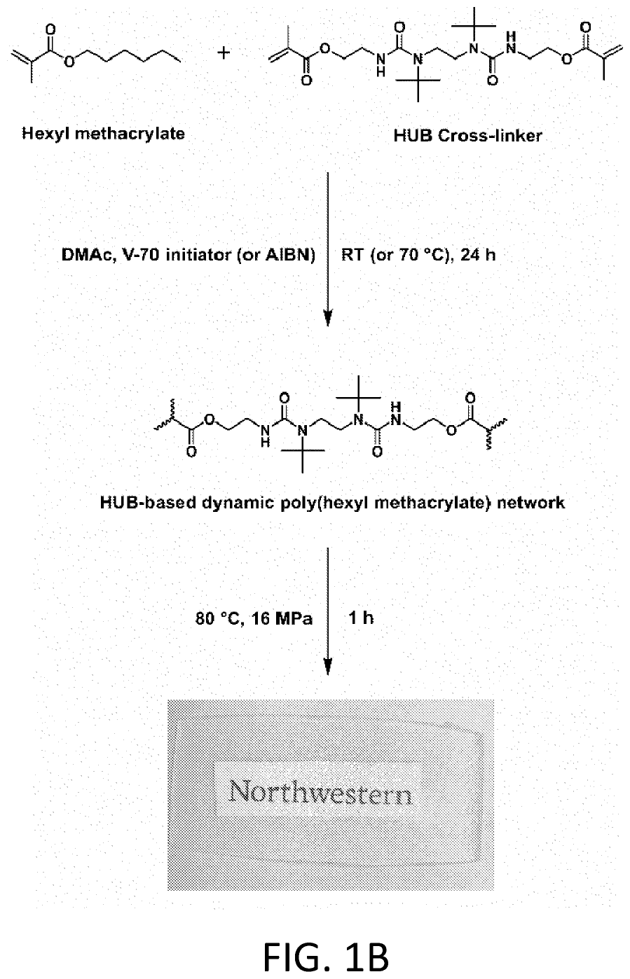

The thermomechanical properties of the 1st mold HUB-based polymethacrylate network sample were characterized by dynamic mechanical analysis (DMA). FIG. 2 shows that the tensile storage modulus (E′) of the network exhibited a quasi-rubbery plateau well above T_{g} (>80° C.), confirming the cross-linked nature. When T increased above 150° C., E′ decreased gradually, indicating a loss in cross-link density. This decrease is consistent with a higher dissociation rate of dynamic HUBs at sufficiently high T. However, contrary to what is expected of a dissociative network, the HUB-based network sample did not exhibit terminal flow at high T. Instead, above T≈215° C., E′ started to increase, indicating an increase in cross-link density. The enhancement in E′ at high Tis attributed to additional cross-linking caused by side reactions involving isocyanates generated from the network dissociation at high T. With increasing T above ˜260° C., E′ started to decrease again, suggesting that dynamic HUB cross-links were dissociating at a higher rate than the formation of permanent cross-links from the isocyanate side reactions. Eventually, at high T and with sufficient time, the dynamic HUB cross-links present in the network will be mostly replaced by permanent cross-links.

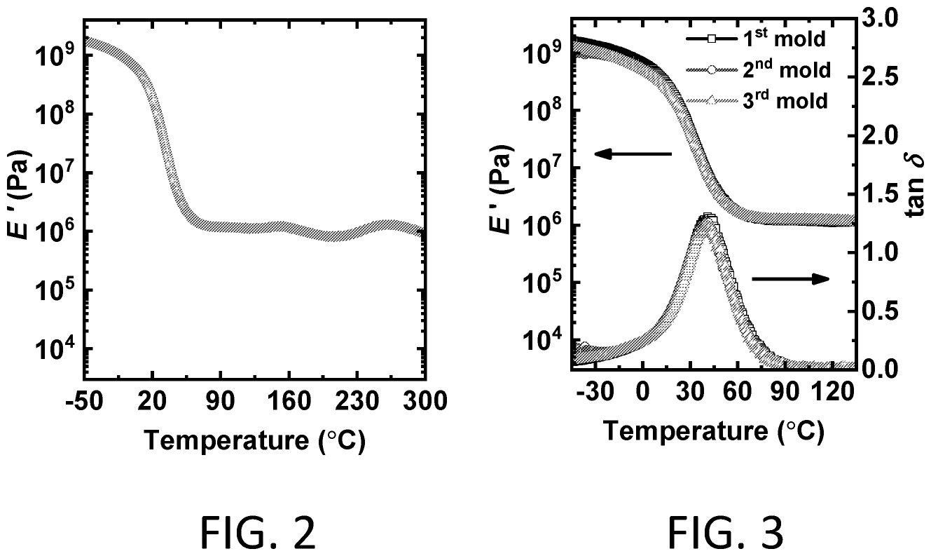

DMA was also used to evaluate the recovery of the network properties after recycling. FIG. 3 illustrates the T-dependent DMA properties, including E′ and tan δ, of the 1^{st} mold, 2^{nd} mold, and 3^{rd} mold network samples. The E′ curves of all samples display a quasi-rubbery plateau well above T_{g}, a characteristic of cross-linked materials. As shown in Table 1, no change was detected in the tan δ peak T after two reprocessing steps. Importantly, within error, the three (re)processed samples exhibited identical E′ values in the rubbery plateau region. Based on Flory's ideal rubber elasticity theory, which indicates that the rubbery plateau modulus is linearly related to cross-link density, the results demonstrate full recovery of cross-link density within error after multiple recycling steps. (Flory, P. J. Principles of Polymer Chemistry; Cornell University Press, 1953.) The results presented here demonstrate that HUB chemistry can be employed in the synthesis of reprocessable polymer networks made only from vinyl monomers that exhibit complete property recovery associated with cross-link density after multiple recycling steps.

TABLE 1
Properties of a HUB-Based Polymethacrylate Network
as a Function of (Re)processing Cycles.

| | Gel content | T_{g} ^{a} | E′ (@ 120° C.) | Tan (δ) peak T |
|---|---|---|---|---|
| Sample | (%) | (° C.) | (MPa) | (° C.) |
| As-synthesized | >99 | 16 | — | — |
| 1^{st} mold | >99 | 15 | 1.09 ± 0.08 | 40 ± 1 |
| 2^{nd} mold | >99 | 15 | 1.19 ± 0.06 | 40 ± 1 |
| 3^{rd} mold | >99 | 16 | 1.17 ± 0.08 | 40 ± 1 |

^{a} Measured by DSC.

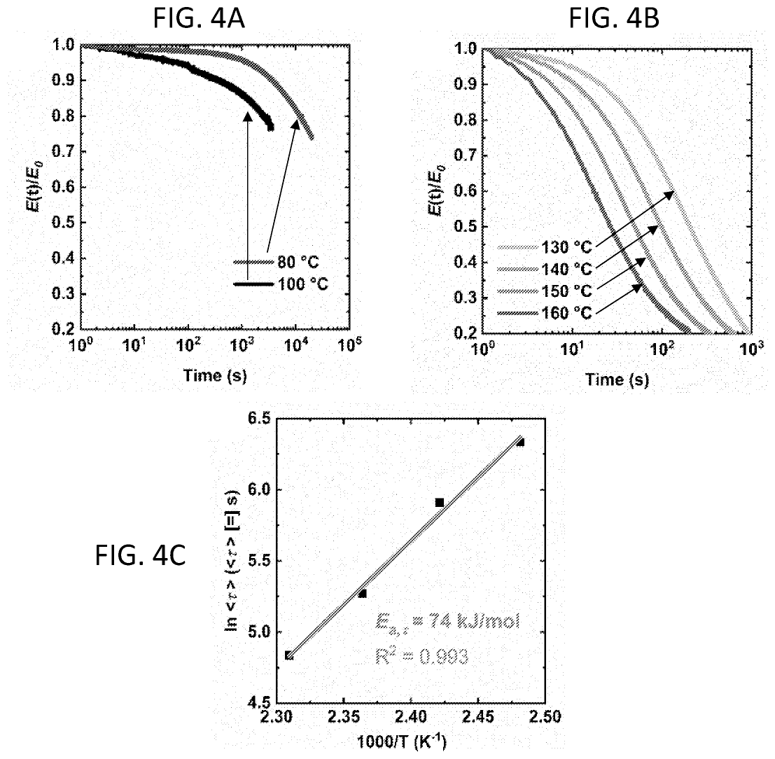

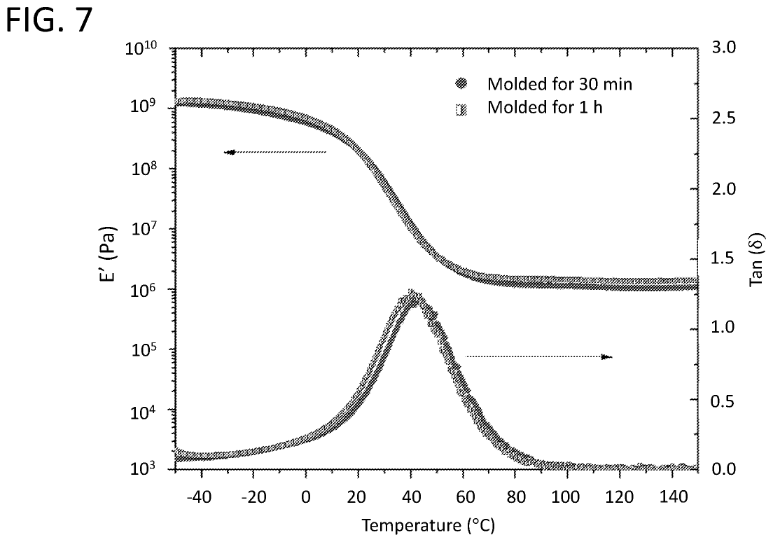

Stress relaxation experiments were performed on 1^{st} mold HUB-cross-linked polymethacrylate networks. Samples were equilibrated at the desired T for at least 10 min before a constant 5% tensile strain was applied. FIG. 4A shows stress relaxation curves at 80° C. and 100° C. At 80° C., the sample acted essentially as a permanent network for the first 5 min as it showed almost no stress relaxation. After 5 min, the sample showed a small degree of progressive stress relaxation but at a very slow rate. The network exhibited only 25% stress relaxation when the test experiment was stopped, more than 5.5 h after the strain was initially applied. Even at 100° C., the network showed a relatively low level of stress relaxation after more than 1 h. Notably, although τ* (τ*, defined as the time when residual stress=1/e (37.8%)) was not reached after more than 5.5 h at 80° C., the synthesized samples were processable at both 80° C. and 60° C. with a processing time of 1 h. It was also found that the network can be reprocessed at 80° C. for 30 min without compromising the quality of the molded sheet (FIG. 7).

Stress relaxation of the 1^{st} mold network samples were also characterized at 130-160° C. As shown in FIG. 4B, the network exhibited much faster stress relaxation at 130-160° C. than at 80° C. and 100° C., indicating a large degree of bond reconfiguration in this T-range. Stress relaxation data were fit via the Kohlrausch-Williams-Watts (KWW) stretched exponential decay function (eqn. 1). (Bin Rusayyis, M. A. et al., Polym. Chem. 2021, 12, 2760-2771; Chen, X. et al., ACS Appl. Mater. Interfaces 2019, 11, 2398-2407; Li, L. et al., Macromolecules 2019, 52, 8207-8216; Ishibashi, J. S. A. et al., Macromolecules 2021, 54, 3972-3986.) The fitting parameters, τ* and β (stretching exponent used to measure breadth of relaxation distribution), and the calculated average relaxation times, <τ> (eqn. 2), are shown in Table 2. Both τ* and <τ> decreased significantly with increasing T, consistent with more decross-linking of the network at higher T. Notably, β values decreased with increasing T. This trend was attributed to the reduction in the network character at higher T. The average relaxation times exhibited an Arrhenius T-dependence (FIG. 4C). The apparent activation energy (Eₐ) associated with stress relaxation in the 130-160° C. T-range was 74 KJ mol⁻¹.

$$\frac{E ( t )}{{E}_{0}} = exp [ - {( \frac{t}{{τ}^{*}} )}^{β} ] \qquad ( 1 )$$

$$〈 τ 〉 = \frac{{τ}^{*} Γ ( 1 / β )}{β} \qquad ( 2 )$$

TABLE 2
KWW Function Parameters and Average Relaxation
Times Obtained from Best Fits to Stress
Relaxation Data at Various Temperatures.

| T (° C.) | τ* (s) | β | <τ> (s) | R² |
|---|---|---|---|---|
| 130 | 394 | 0.63 | 563 | 0.993 |
| 140 | 211 | 0.54 | 368 | 0.977 |
| 150 | 108 | 0.53 | 195 | 0.972 |
| 160 | 62 | 0.49 | 126 | 0.959 |

The results demonstrate the facile synthesis and incorporation of a HUB-based cross-linker into addition-type networks. It was shown that HUB-based polymethacrylate networks can be efficiently (re)processed multiple times under mild conditions compared to other dynamic network systems, with full recovery of cross-link density after recycling. The networks did not flow and retained their cross-linked nature up to 300° C. Contrary to common expectations, these networks showed very slow stress relaxation at processing T, revealing the importance of pressure on the processability of dynamic polymer networks and the limitations of stress relaxation experiments. Despite its dissociative nature, at 130-160° C. the network exhibited an Arrhenius T-dependence of average stress relaxation time.

### Materials and Synthetic Procedures

### Materials

All chemicals are commercially available and used as received unless otherwise noted. 2-Isocyanatoethyl methacrylate and N,N′-di-tert-butylethylenediamine were purchased from TCI America. Dichloromethane (DCM, Certified ACS) and methanol (99.9%) were supplied by Fisher. Hexyl methacrylate (HMA, 98%), azobisisobutyronitrile (AIBN, 98%), N,N-dimethylacetamide (DMAc, anhydrous, 99.8%), toluene (99.9%) and chloroform-d (99.8 atom % D) were from Sigma-Aldrich. V-70 initiator was obtained from FUJIFILM Wako Chemicals. Hexyl methacrylate (HMA) monomer was de-inhibited using inhibitor remover (Sigma Aldrich, 311340) in the presence of calcium hydride (Sigma Aldrich, 90%). AIBN was recrystallized from methanol. DCM used in the synthesis of the cross-linker and DMAc were dried over 4 Å molecular sieves for at least 48 h before use.

### Synthesis of 5,8-di-tert-butyl-4,9-dioxo-3,5,8,10-tetraazadodecane-1,12-diyl bis(2-methylacrylate), (HUB Cross-linker

2-Isocyanatoethyl methacrylate (2.01 g, 12.94 mmol) and pre-dried DCM (6 mL) were mixed in a 20-mL glass vial at room temperature. A solution of N,N′-di-tert-butylethylenediamine (1.12 g, 6.49 mmol) and pre-dried DCM (2 mL) was slowly added to the vial and the mixture was stirred at room temperature for 30 min. The solvent (DCM) was then removed to obtain the cross-linker as a white solid (3.05 g) (yield: 98%; melting point: 93° C.). ¹H NMR (500 MHZ, CDCl₃) δ 6.24 (t, J=5.3 Hz, 2H), 6.13 (s, 2H), 5.56 (s, 2H), 4.26 (t, J=5.5 Hz, 4H), 3.53 (q, J=5.4 Hz, 4H), 3.26 (s, 4H), 1.94 (s, 6H), 1.41 (s, 18H). ¹³C NMR (126 MHz, CDCl₃) δ 167.5, 159.3, 136.3, 125.6, 64.1, 54.8, 46.2, 40.0, 29.9, 18.3.

### Synthesis of Network

Reprocessable polymer networks containing dynamic hindered urea bonds were synthesized via free radical polymerization by reacting hexyl methacrylate with HUB Cross-linker and V-70 initiator. In a typical synthesis, HUB Cross-linker (761.9 mg, 1.58 mmol) was dissolved in hexyl methacrylate (5.05 g, 29.66 mmol) in a 20-mL glass vial using DMAc (3.0 mL) as a solvent. The solution was stirred at room temperature until the cross-linker was completely dissolved, after which V-70 initiator (95.0 mg, 0.31 mmol) was added and stirred to dissolve the initiator. The solution was then bubbled with nitrogen (N2) gas at room temperature for 20 min, and then N2 gas was allowed to continuously flow into the vial. The polymerization proceeded at room temperature for 24 h after which it was quenched by exposing it to air. The obtained network was cut into small pieces, washed with DCM/methanol mixtures, and then dried in a vacuum oven at 50° C. for at least 24 h. Networks synthesized using AIBN were made in a similar way with the polymerization done at 70° C.

### Characterization and Molding Methods

### NMR Spectroscopy

¹H- and ¹³C-NMR spectroscopy were performed at room temperature using a Bruker Avance III 500 MHz NMR spectrometer. Deuterated chloroform (CDCl₃) was used as solvent, and the spectra were reported relative to tetramethylsilane.

### Fourier Transform Infrared (FTIR) Spectroscopy

Attenuated total reflectance-Fourier transform infrared (ATR-FTIR) spectroscopy was performed using a Bruker Tensor 37 FTIR spectrophotometer equipped with a diamond/ZnSe attachment. Sixteen scans were collected at room temperature over the 4000 to 600 cm 1 range at 4 cm 1 resolution.

### Differential Scanning Calorimetry (DSC)

The melting temperature (Tₘ) of the synthesized cross-linker and the glass transition temperatures (T_{g}s) of as-synthesized and molded networks were obtained by DSC using a Mettler Toledo DSC822e. The Tₘ value of the cross-linker was determined from the endothermic peak of the first heating cycle (heating rate 10° C. min⁻¹). To determine the T_{g}s of the networks, network samples were annealed at −50° C. for 5 min followed by heating to 80° C. at a heating rate of 10° C. min⁻¹. The samples were then cooled again to −50° C. (cooling rate—10° C. min⁻¹) and then heated to 80° C. at a heating rate of 10° C. min⁻¹. T_{g} values were obtained from the heating ramp of the second heating cycle using the ½ ΔCₚ method.

### Swelling

Swelling tests were performed by placing network samples in a 20-mL glass vial filled with toluene. The samples were allowed to swell for at least 72 h to reach equilibrium. Swollen samples were dried in a vacuum oven for at least 48 h to obtain gel fractions.

### Molding and Reprocessing of Networks

(Re)processing of dried, as-synthesized networks was done by hot pressing small network pieces into ˜1 mm-thick sheets using a PHI press (Model 0230C-X1). Unless otherwise noted, the materials were (re)processed at 80° C. with a pressure of 16 MPa for 1 h.

### Dynamic Mechanical Analysis (DMA)

DMA was performed using a TA Instruments RSA-G2 Solids Analyzer to characterize the thermo-mechanical performance of the network samples and evaluate recovery of cross-link density after each recycling step. In DMA experiments, tensile storage modulus (E′), tensile loss modulus (E″), and the damping ratio (tan δ=E″/E′) of the network samples were measured as functions of temperature under nitrogen atmosphere. The network rectangular specimens were heated from −55° C. to 150° C. (or 300° C.) at a heating rate of 3° C. min⁻¹. The tension-mode measurements were collected at a frequency of 1 Hz and 0.03% oscillatory strain. Three measurements were performed for each sample, and the E′ value at 120° C. was reported as the average rubbery plateau modulus with errors given by two standard deviations (Table 1).

### Stress Relaxation

Uniaxial stress relaxation measurements were performed on rectangular samples of the 1^{st} mold network using a TA Instruments RSA-G2 Solids Analyzer. Samples were first annealed at the desired temperature for 10 min before a constant 5% tensile strain was applied. The stress relaxation modulus was recorded until at it had relaxed to 20% of its initial value. Stress relaxation data were fitted to the following Kohlrausch-Williams-Watts (KWW) stretched exponential decay function (equation 1): (Dhinojwala, A. et al., J. Non-Cryst. Solids 1994, 172-174, 286-296) where E(t)/E₀ is the normalized relaxation modulus at time t, τ* is the characteristic relaxation time, and β (0<β≤1) is the stretching exponent that serves as a shape parameter characterizing the breadth of the relaxation distribution. The average relaxation time, <τ>, is given by equation 2. (Dhinojwala, A. et al., 1994)

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A method of forming a dynamic crosslinked polymer network, the method comprising:
forming a mixture of:
a pre-formed organic crosslinker having hindered urea bonds and terminal vinyl groups; or a vinyl monomer comprising a reactive isocyanate group and a monomer comprising a hindered amine group;
a monomer comprising a C—C double bond capable of undergoing addition polymerization; a polymer selected from the group consisting of polymers having a C—C double bond capable of undergoing addition polymerization; or combinations thereof; and
a thermally activated free radical initiator; and
generating free radicals from the thermally activated free radical initiator to induce addition reactions of the organic crosslinker with the monomer, the polymer, or both, to form a dynamic crosslinked polymer network.

2. The method of claim 1, wherein the mixture further comprises an organic solvent.

3. The method of claim 1, wherein the polymer of the dynamic crosslinked polymer network is a homopolymer.

4. The method of claim 3, wherein the homopolymer is poly(n-hexyl methacrylate.

5. The method of claim 1, wherein the pre-formed organic crosslinker having hindered urea bonds and terminal vinyl groups is a dimethacrylate or the vinyl monomer comprising a reactive isocyanate group is a methacrylate monomer.

6. The method of claim 1, wherein the mixture comprises an alkyl (meth)acrylate as the monomer comprising a C—C double bond capable of undergoing addition polymerization.

7. The method of claim 1, wherein the thermally activated initiator is an azo-initiator.

8. The method of claim 1, wherein generating free radicals from the thermally activated free radical initiator comprises heating the mixture to a temperature above room temperature at which the thermally activated free radical initiator decomposes to form free radicals.

9. The method of claim 1, wherein the mixture comprises 5,8-di-tert-butyl-4,9-dioxo-3,5,8,10-tetraazadodecane-1,12-diyl bis(2-methylacrylate) as the pre-formed organic crosslinker, hexyl methacrylate as the monomer comprising a C—C double bond capable of undergoing addition polymerization, and an azo initiator as the thermally activated free radical initiator.

10. The method of claim 9, wherein the mixture further comprises N,N-dimethylacetamide as an organic solvent.

11. The method of claim 1, wherein the mixture comprises 2-isocyanatoethyl methacrylate as the vinyl monomer comprising a reactive isocyanate group, N,N′-di-tert-butylethylenediamine as the monomer comprising a hindered amine group, hexyl methacrylate as the monomer comprising a C—C double bond capable of undergoing addition polymerization, and an azo initiator as the thermally activated free radical initiator.

12. The method of claim 1, further comprising pressing the dynamic crosslinked polymer network in a mold at a temperature that induces reversible urea bond cleavage; and cooling the dynamic crosslinked polymer network to a temperature at which the reversible urea bond cleavage is arrested to form a processed dynamic crosslinked polymer network.

13. The method of claim 12, wherein the temperature that induces reversible urea bond cleavage is in the range from 23° C. to 200° C.

14. The method of claim 12, further comprising heating the processed dynamic crosslinked polymer network to a temperature that induces reversible urea bond cleavage; reshaping the processed dynamic crosslinked polymer network; and cooling the reshaped dynamic crosslinked polymer network to a temperature at which the reversible urea bond cleavage is arrested to form a reprocessed dynamic crosslinked polymer network.

15. The method of claim 14, wherein the reprocessed dynamic crosslinked polymer network has a crosslink density that is no lower than the crosslink density of the processed dynamic crosslinked polymer network.

16. A method of processing a dynamic crosslinked homopolymer network comprising the reaction product of 5,8-di-tert-butyl-4,9-dioxo-3,5,8,10-tetraazadodecane-1,12-diyl bis(2-methylacrylate) and an alkyl (meth)acrylate monomer, the method comprising pressing the dynamic crosslinked polymer network in a mold at a temperature that induces reversible urea bond cleavage; and cooling the dynamic crosslinked polymer network to a temperature at which the reversible urea bond cleavage is arrested to form a processed dynamic crosslinked polymer network.

17. The method of claim 16, wherein the temperature that induces reversible urea bond cleavage is in the range from 23° C. to 200° C.

18. The method of claim 16, further comprising heating the processed dynamic crosslinked polymer network to a temperature that induces reversible urea bond cleavage; reshaping the processed dynamic crosslinked polymer network; and cooling the reshaped dynamic crosslinked polymer network to a temperature at which the reversible urea bond cleavage is arrested to form a reprocessed dynamic crosslinked polymer network.

19. The method of claim 18, wherein the reprocessed dynamic crosslinked polymer network has a crosslink density that is no lower than the crosslink density of the processed dynamic crosslinked polymer network.

20. A method of making an organic crosslinker having a hindered urea bond, the method comprising:
reacting a first monomer comprising an isocyanate group and at least one additional group having a C—C double bond capable of undergoing addition polymerization with a second monomer comprising a hindered amine group, in the absence of a catalyst, to form an organic crosslinker, the organic crosslinker comprising at least two groups comprising a C—C double bond capable of undergoing addition polymerization and a hindered urea bond, wherein one or both of the at least two groups comprising a C—C double bond capable of undergoing addition polymerization is a methacrylate group, an acrylamide group, an isophenyl group, a vinyl ether group, an allyl group, or an allyl ether group; and
removing the organic crosslinker comprising from the organic solvent.

21-24. (canceled)
